(19) United States
(12) Patent Application Publication
(10) Pub. No.: US 2008/0317462 A1
(43) Pub. Date: Dec. 25, 2008

(54) OPTICAL FIBER LINK MONITORING METHOD AND APPARATUS FOR PASSIVE OPTICAL NETWORK

(76) Inventor: Teng-Yuan Chi, Taipei (TW)

Correspondence Address: BIRCH STEWART KOLASCH & BIRCH, PO BOX 747, FALLS CHURCH, VA, 22040-0747, US

(21) Appl. No.: 11/765,352

(22) Filed: Jun. 19, 2007

(51) Int. Cl. H04B 10/08; H04B 17/00

(52) U.S. Cl. 398/13

(57) ABSTRACT

The present invention provides an optical link monitoring method for the passive optical network. The method includes the steps of: determining a plurality of groups such that each group includes portion of a plurality of optical network units; connecting each of the plurality of groups to an optical splitter through an optical fiber link; determining status of the optical fiber links among an optical line terminal, the optical splitter and the plurality of groups according to the upstream optical signals or optical energy accepted by the optical line terminal. The present invention also provides an apparatus and a system to implement the method.

### BACKGROUND OF THE INVENTION

1. Field of the Invention

The present invention generally relates to an optical fiber link monitoring method and apparatus for passive optical network, and more particularly to the technology of detecting abnormal optical fiber links for tree-type passive optical network by using a corresponding relation between optical network unit groups and optical fiber links.

2. Description of the Prior Art

Optical network cables are usually affected by the outer factors such as temperature variation, external force pressure, and even deliberate destruction by people, which generally results in damage or breaking of internal optical fibers such that the signal transmission may be interrupted or the overall communication quality may be deteriorated. Therefore it is a necessary action to monitor optical fiber network, while cost and efficiency should be taken into consideration.

FIG. 1 shows the conventional tree-type passive optical network configuration 100, which includes an optical line terminal 102, optical splitters 104-112 and optical network units 121-136. In this figure, all optical splitters 104-112 are 1:4 splitters, so there are totally 16 optical network units 121-136. The optical line terminal 102 communicates with the optical network units 121-136 by using the time division multiplexing (TDM) technology. In a normal status, the optical line terminal 102 keeps transmitting or broadcasting downstream optical signals to the optical network units 121-136 and receiving upstream optical signals therefrom.

The optical line terminal 102 is usually located in a line terminal control center. It provides an information exchanging or dispatching service between a passive optical network system (OLT client end) and branch network (OLT network end), which means gathering data from the client end, properly processing the data, and then sending the data to the network end, or dealing with the data from the network end and then sending them to the client end. The client end uses a passive optical network interface, but the network end usually sets synchronized optical network or a T3 interface.

Optical network units (ONU) 121-136 are similar to Ethernet devices. Every ONU has a unique ID (identification). Usually they are installed in specific facilities near the client end. An ONU provides a service interface between a passive optical network system (ONU network end) and a personal computer or internal local network (ONU client end).

A traditional optical link monitoring method usually uses the Optical Time-Domain Reflectometry (OTDR) to measure if the transmission of an optical signal is abnormal. The OTDR itself is an expensive apparatus, and the measurement method includes transmitting constant width optical pulses from one end of the optical fiber, and using a high-sensitivity optical detector to receive the reflected signals of the optical pulses in different time. Because the optical signals will keep attenuating, a user can get the relative OTDR trace plot (The principle is that the reflected light which the detector receives will reduce when time increases.) to realize the dissipation status of the optical transmission. When somewhere in the trace plot has abnormal optical dissipation, the system can know where an abnormal status exists. But the premise is that the distance from every ONU to the optical splitter should be apparently different, otherwise the system can't find out where the abnormal status exists.

If more than one optical network branch links have similar length, then the system can't clearly understand where the abnormal status exists from the OTDR trace plot directly. Under that circumstance, the only way the system can do is taking a time-consuming method, i.e., to measure the passive optical network at the optical splitter end directly instead monitor them on the head end.

Therefore a need has arisen to propose an improved optical fiber link monitoring method and apparatus for passive optical network, so as to save the cost and time when applied to optical network branches with similar length as well as improve the shortcomings of the traditional OTDR.

### SUMMARY OF THE INVENTION

It is an object of the present invention to provide an optical fiber link monitoring method for passive optical network, the method using a corresponding relation between ONU groups and the optical fiber links to detect the optical link faults in a tree-type passive optical network.

Another object of the present invention is to provide an optical fiber link monitoring apparatus for passive optical network to detect the optical link faults in a tree-type passive optical network.

According to the above objects, the present invention provides an optical fiber link monitoring method for passive optical network, the method being applied to an optical network configuration including an optical line terminal, a first optical splitter, a plurality of optical network units (ONUs) and a plurality of optical fiber links including a main optical fiber link connecting between the optical line terminal and the first optical splitter, the optical fiber link monitoring method including the steps of: grouping the plurality of optical network units into a plurality of groups such that each of the plurality of groups includes a portion of the plurality of optical network units; connecting each of the plurality of groups to the first optical splitter through one of the plurality of optical fiber links; and determining status of the optical fiber links among the optical line terminal, the first optical splitter and the plurality of groups according to upstream optical signals or optical energy transmitted from the plurality of groups and detected by the optical line terminal.

The present invention also provides an optical network system with optical fiber link monitoring capability, the system including an optical line terminal, an optical splitter connecting to the optical line terminal through a main optical fiber link, and a plurality of optical network units grouped into a plurality of groups connecting to the optical splitter respectively through optical fiber links, in which the optical line terminal includes at least one monitoring unit configured to catch upstream optical signals or optical energy from the plurality of groups and determine statuses of the main optical fiber link and the optical fiber links according to the caught upstream optical signals or optical energy.

The present invention also provides an optical fiber link monitoring apparatus for the passive optical network, the apparatus being applied to an optical network configuration including an optical line terminal, an optical splitter, a plurality of optical network units (ONUs) connecting thereamong through optical fiber links, the plurality of optical network units being grouped into a plurality of groups such that each of the plurality of groups includes a portion of the plurality of optical network units, the optical fiber link monitoring apparatus including an optical energy fetch element configured to fetch upstream optical energy transmitted from the plurality of groups and a detecting/analyzing module configured to detect intensity of the upstream optical energy and determine status of the optical fiber links among the optical line terminal, the optical splitter and the plurality of groups according to the intensity of the upstream optical energy.

### BRIEF DESCRIPTION OF THE DRAWINGS

FIG. 1 shows the conventional tree-type optical network configuration.

FIG. 2 shows the optical network system with the optical fiber link monitoring capability according to one embodiment of the present invention.

FIG. 2A to 2C illustrate the cases in which various kinds of broken links occur in the optical network of FIG. 2.

FIG. 3 shows the upstream optical power distribution of normal optical network units.

FIG. 3A to 3C separately show the upstream optical power distribution corresponding to FIG. 2A to 2C.

FIG. 4 shows the optical fiber link monitoring method for the passive optical network according to one embodiment of the present invention.

FIG. 4A shows the flowchart for judging the optical fiber link status of the optical fiber link monitoring method for the passive optical network according to an embodiment of the present invention.

FIG. 5 shows the optical network system with the optical fiber link monitoring capability according to another embodiment of the present invention.

FIG. 6 shows the block diagram of the detecting/analyzing module of FIG. 5 according to one embodiment of the present invention.

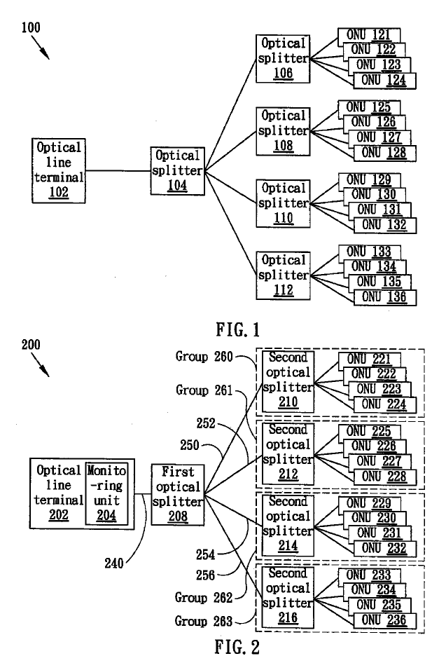

### DETAILED DESCRIPTION OF THE INVENTION

Preferred embodiments of the present invention will be described below in detail with reference to the accompanying drawings. It is to be understood that other embodiments may be utilized, as structural and operational changes may be made without departing from the scope of the present invention. Moreover, the drawings are only shown to the extent necessary for disclosing the features of the invention, in which like reference numbers designate the same or similar parts throughout the figures.

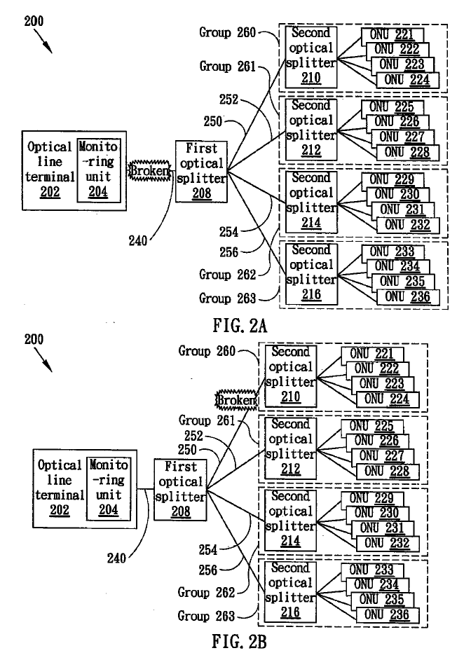

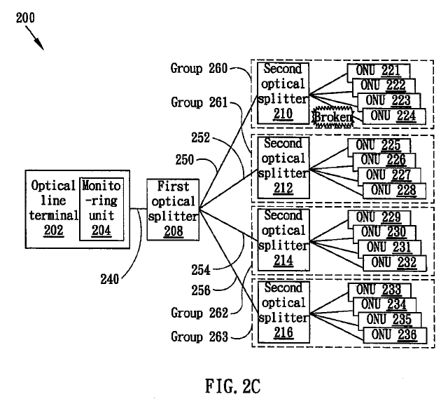

FIG. 2 shows a schematic diagram of the optical network system 200 with the optical fiber link monitoring capability according to one embodiment of the present invention. It includes an optical line terminal 202, a first optical splitter 208, a plurality of second optical splitters 210-216, and a plurality of optical network units (ONUs) 221-236. The optical line terminal 202 connects to the first optical splitter 208 through the main optical fiber link 240. The first optical splitter 208 connects to the second optical splitters 210-216 respectively through the optical fiber links 250-256. The second optical splitters 210-216 connect to the optical network units 221-236 respectively through other optical fiber links as shown in FIG. 2.

The plurality of second optical splitters 210-216 and the plurality of optical network units 221-236 are grouped or classified into groups 260-263 as shown in FIG. 2. The group 260 includes the second optical splitter 210 and the optical network units 221-224; the group 261 includes the second optical splitter 212 and the optical network units 225-228; the group 262 includes the second optical splitter 214 and the optical network units 229-232, and the group 263 includes the second optical splitter 216 and the optical network units 233-236.

The optical line terminal 202 has a monitoring unit 204 to catch the upstream optical signals or energy from the groups 260-263. The monitoring unit 204 determines if any optical fiber link has an abnormal status or is broken according to the intensity of the caught upstream optical signals or energy. For example, if none of the upstream optical signals or energy from the group 260 is normal (but that from other groups are all normal), then a user may conclude that the optical fiber link 250 which connects to the group 260 may have an abnormal status. Moreover, if none of the upstream optical signals or energy from all the groups 260-263 is normal, then it may be determined that the main optical fiber link 240 between the first optical splitter 208 and the optical line terminal 202 is in an abnormal status. In another case, if only part of optical network units contained in the group 260 have abnormal upstream optical signals or energy, then it may be determined that the optical fiber links directly connecting to that part of optical network units having abnormal upstream optical signals are abnormal.

The internal configuration of the monitoring unit 204 can be, but not limit to, the combination of the detecting/analyzing module 206 and the optical energy fetch clement 209 shown in FIG. 6. Please refer to the description of FIG. 6 for details.

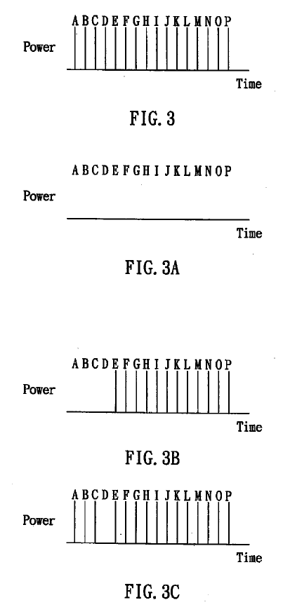

Following describes the relation between various kinds of link broken situations and the upstream optical energy or power fetched from every ONU to help realize the principle of the present invention. To simplify the description, the Optical Network Unit is sometimes referred to as the ONU in the following description. In the following description, we assume that when the whole optical fiber links are normal, the upstream optical power distribution of every ONU is as shown in FIG. 3 (in FIG. 3, letters A-P respectively represent ONU 221-236, and the same convention is applied to FIG. 3A, FIG. 3B and FIG. 3C). To simplify the description, we assume that, in the normal case, ONUs 221-236 all return the identical optical power intensity. In the real case, they may be different. In other words, the normal range of each ONU upstream optical power can be different. The network administration center may manually and independently set the normal ranges of upstream optical power corresponding to all ONUs according to the real situation. The manually setting normal ranges are then used as the criteria for faults detection. Besides, all following examples are described based on the configuration, reference names and numbers shown in FIG. 2.

FIG. 2A illustrates a case that a broken link occurs in the passive optical network 200 of FIG. 2. In this case, the broken point lies in somewhere of the main optical fiber link 240 which connects between the monitoring unit 204 and the first optical splitter 208. In this case, the monitoring unit 204 will detect the ONU upstream optical power distribution as shown in FIG. 3A. The main optical fiber link 240 is the indispensable route for the entire ONUs in all the groups 260-263 to communicate with the optical line terminal 202. If it is broken, then all upstream signals will disappear at the same time. Accordingly, when none of the upstream signals of all ONUs in all the groups 260-263 lies in the normal range, then it is feasible to assert that the main optical fiber link 240 corresponding to groups 260-263 has troubles. FIG. 2B illustrates another case that a broken link occurs in the passive optical network 200 of FIG. 2. In this case, the broken point occurs in somewhere of the optical fiber link 250 which connects between the first optical splitter 208 and the second optical splitter 210. In this case, the monitoring unit 204 will detect the ONU upstream optical power distribution as shown in FIG. 3B. The optical fiber link 250 is the indispensable route for the ONUs 221-224 to communicate with the optical line terminal 202 (and any ONU other than 221-224 need not to pass through the optical fiber link 250 to communicate with the optical line terminal 202). Once the optical fiber link 250 is broken, then the upstream signals corresponding to ONUs 221-224 will all disappear. Accordingly, if ONUs 221-224 are grouped into the same group 260, and when none of the upstream signals of all ONUs in group 260 lies in normal ranges, then it is feasible to assert that the optical fiber link 250 corresponding to group 260 has troubles.

FIG. 2C illustrates still another case that a broken link occurs in the passive optical network 200 of FIG. 2. In this case, somewhere of the optical fiber link between the optical splitter 210 and ONU 224 is broken. In this case, the monitoring unit 204 will detect the ONU upstream optical power distribution as shown in FIG. 3C. Because the broken link is the necessary route for the ONU 224 to communicate with the optical line terminal 202 (and any ONU other than ONU 224 need not to pass through the broken link to communicate with the optical line terminal 202), the upstream signal of ONU 224 corresponding to the broken link will disappear. Accordingly, when the upstream signal of ONU 224 does not lie in the normal range, it is feasible to determine that the corresponding optical fiber link may have problems.

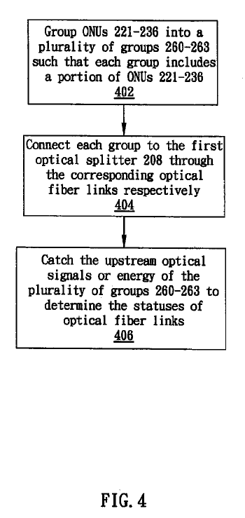

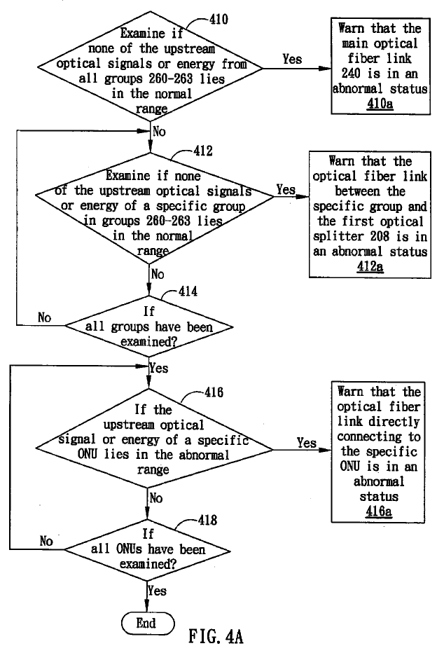

According to above disclosure, it should be appreciated that the present invention also provides an optical fiber link monitoring method for the passive optical network. FIG. 4 shows the optical fiber link monitoring method for the passive optical network according to one embodiment of the present invention. This method can be applied to the optical network configuration as FIG. 2 shows. The following description will refer to the designation numbers used in FIG. 2. The optical fiber network monitoring method shown in FIG. 4 includes steps 402-406. Step 402 group ONUs 221-236 into a plurality of groups 260-263 such that each group includes a portion of the plurality of ONUs 221-236. For example, groups 260-263 may be formed in the same manner described in FIG. 2. All ONUs in the same group must pass through a specific optical fiber link to communicate with the optical line terminal 202, while it is not necessary for any ONU which doesn't belong to the group to pass through the specific optical fiber link to communicate with the optical line terminal 202. According to this rule, every group can correspond to a specific optical fiber link (as in FIG. 2, the group 260 which includes ONUs 221-224 corresponds to the optical fiber link 250). The groups 260-263 mentioned above may further respectively include the second splitters 210-216 as shown in FIG. 2 such that the connection between the groups and the corresponding optical fiber links may be clearly understood. In step 404, each group is connected to the first optical splitter 208 through the corresponding optical fiber links respectively. In step 406, the optical line terminal 202 catches the upstream optical signals or energy of the plurality of groups 260-263 to determine the statuses of optical fiber links connecting among the optical line terminal 202, the first optical splitter 208 and the plurality of groups 260-263. Please refer to the description of FIG. 4A for how to judge the status of optical fiber links.

FIG. 4A shows the flowchart for judging the optical fiber link status of the optical fiber link monitoring method for the passive optical network. The following description also refers to the designation numbers used in FIG. 2. Step 410 is to examine if none of the upstream optical signals or energy from all groups 260-263 lie in the normal range. If none of them lies in the normal range, then step 410a is executed to warn that the main optical fiber link 240 is in an abnormal status; otherwise the flow proceeds to execute step 412.

Step 412 is to examine if none of the upstream optical signals or energy of a specific group in groups 260-263 lies in the normal range. If none of them lies in the normal range, then step 412a is executed to warn that the optical fiber link between the specific group and the first optical splitter 208 is in an abnormal status; otherwise the flow proceeds to execute step 414. Step 414 is to determine if all groups have been examined. If there is an unexamined group, then return to step 412 to keep examining the next specific group; otherwise, the flow proceeds to execute step 416.

Step 416 is to examine if the upstream optical signal or energy of a specific ONU lies in the abnormal range. If it is abnormal, then step 416a is executed to warn that the optical fiber link directly connecting to the specific ONU is in an abnormal status; otherwise the flow proceeds to execute step 418. Step 418 is to determine if all ONUs have been examined. If there is an unexamined ONU, then return to step 416 and keep examining the next specific ONU; otherwise, the flow is ended.

The procedures of FIG. 4 and FIG. 4A can be controlled by the central processing unit 206A shown in FIG. 6. Judging if an upstream optical signal or energy is abnormal or not is according to the normal range of the upstream optical signal intensity respectively set for each ONU. Different ONUs may have different normal intensity ranges.

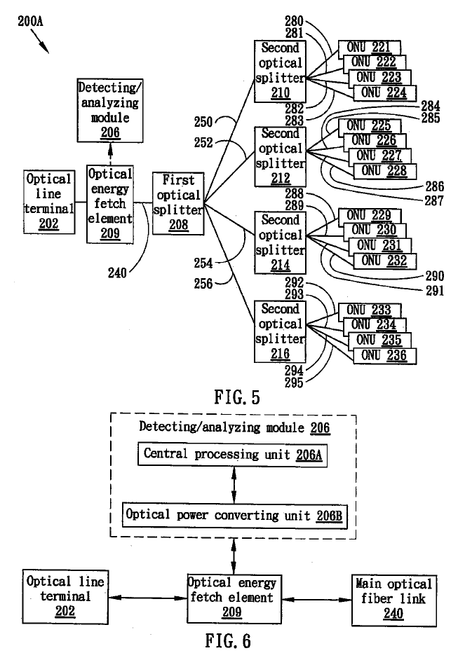

FIG. 5 shows a schematic diagram of the optical network system 200A with the optical fiber link monitoring capability according to another embodiment of the present invention. It includes an optical line terminal 202, an optical energy fetch element 209, a detecting/analyzing module 206, optical splitters 208-216 and ONUs 221-236. The optical energy fetch element 209 connects to the optical line terminal 202 and the detecting/analyzing module 206. It also connects to the optical splitter 208 through the optical fiber link 240. The optical splitter 208 connects to the optical splitters 210, 212, 214 and 216 respectively through the optical fiber links 250, 252, 254 and 256. The four optical splitters 210-216 further connect to ONUs (221-224, 225-228, 229-232, 233-236) respectively through the optical fiber links (280-283, 284-287, 288-291, 292-295). This configuration adds the optical energy fetch element 209 and the detecting/analyzing module 206 between the optical line terminal 202 and the optical splitter 208 to the conventional system. Practically, the optical energy fetch element 209 and the detecting/analyzing 206 can be combined into a module, or even incorporated into the optical line terminal 202.

The optical energy fetch element 209 can be, but not limit to, a module including an optical splitter and an optical filter or a module including an optical splitter and a wave division multiplexer (WDM). Based on the time division multiplexing protocol, the optical energy fetch element 209 may fetch the upstream optical signal energy transmitted from the ONUs 221-236 to the optical line terminal 202, and then transmit the fetched optical energy to the detecting/analyzing module 206 for further analyzing. The functions of the detecting/analyzing 206 include detecting and analyzing the optical energy fetched by the optical energy fetch element 209. The internal structure thereof is described in the embodiment of FIG. 6. The detecting/analyzing module 206 analyzes the received ONUs upstream signals based on the group concept as described in aforementioned embodiments.

The detecting/analyzing module 206 transforms and analyzes the optical energy fetched by the optical energy fetch element 209 based on the concept that all optical fiber links correspond to a specific group as mentioned above. When it detects that the communication between all ONUs in the same group and the optical line terminal 202 have trouble, then it determines that the optical fiber link corresponds to the group may be in an abnormal status and should be fixed. The detailed monitoring method has been described in the embodiments of FIG. 4 and FIG. 4A.

FIG. 6 shows the block diagram of the detecting/analyzing module 206 of FIG. 5 according to one embodiment of the present invention. It includes a central processing unit 206A and an optical power converting unit 206B. The optical power converting unit 206B may include an element, such as (but not limit to) a photo diode, to detect and convert optical signals. The function thereof is to perform the optical power detection, for example, to convert optical energy into electric signals for subsequent analysis. The central processing unit 206A can be a general-purpose microprocessor. It is used to analyze the signal transformed by the optical power converting unit 206B, and then determine if any optical fiber link is broken or abnormal. FIG. 6 also shows that the detecting/analyzing module 206 connects to the optical line terminal 202 and the main optical fiber link 240 of the passive optical network through the optical energy fetch element 209. Practically, as mentioned above, the optical energy fetch element 209 and the detecting/analyzing module 206 may be combined into a module, or even incorporated into the optical line terminal 202 to function as the monitoring unit 204 as shown in FIG. 2.

Although specific embodiments have been illustrated and described, it will be appreciated by those skilled in the art that various modifications may be made without departing from the scope of the present invention, which is intended to be limited solely by the appended claims.

What is claimed is:

1. An optical fiber link monitoring method for passive optical network, the method being applied to an optical network configuration comprising an optical line terminal, a first optical splitter, a plurality of optical network units (ONUs) and a plurality of optical fiber links comprising a main optical fiber link connecting between the optical line terminal and the first optical splitter, the optical fiber link monitoring method comprising the steps of:
grouping the plurality of optical network units into a plurality of groups such that each of the plurality of groups comprises a portion of the plurality of optical network units;
connecting each of the plurality of groups to the first optical splitter through one of the plurality of optical fiber links; and
determining status of the optical fiber links among the optical line terminal, the first optical splitter and the plurality of groups according to upstream optical signals or optical energy transmitted from the plurality of groups and detected by the optical line terminal,
wherein the determining step comprises:
if none of the upstream optical signals or optical energy from a specific group of the plurality of groups is normal, then determining that a specific optical fiber link connecting between the specific group and the first optical splitter is abnormal.

2. The method of claim 1, wherein the determining step further comprises:
if none of the upstream optical signals or optical energy from the plurality of groups is normal, then determining that the main optical fiber link is abnormal.

3. The method of claim 1, wherein the determining step further comprises:
if the upstream optical signal or optical energy from a specific optical network unit contained in the specific group is abnormal, then determining that the optical fiber link directly connecting to the specific optical network unit is abnormal.

4. The method of claim 1, wherein each of the plurality of groups further comprises at least one second optical splitter connecting to the portion of the plurality of optical network units through the optical fiber links.

5. The method of claim 1, wherein the upstream optical signal or optical energy is determined to be normal or not according to a normal intensity range respectively set for each of the plurality of optical network units.

6. An optical network system with optical fiber link monitoring capability, comprising:
an optical line terminal;
an optical splitter, connecting to the optical line terminal through a main optical fiber link; and
a plurality of optical network units, grouped into a plurality of groups connecting to the optical splitter respectively through optical fiber links,
wherein the optical line terminal comprises at least one monitoring unit configured to catch upstream optical signals or optical energy from the plurality of groups and determine statuses of the main optical fiber link and the optical fiber links according to the caught upstream optical signals or optical energy.

7. The system of claim 6, wherein the monitoring unit determines that a specific optical fiber link between a specific group of the plurality of groups and the optical splitter is abnormal if none of the caught upstream optical signals or optical energy from the specific group is normal.

8. The system of claim 7, wherein the monitoring unit further determines that the main optical fiber link is abnormal if none of the caught upstream optical signals or optical energy of the plurality of groups is normal.

9. The system of claim 8, wherein the monitoring unit further determines that an optical fiber link directly connecting to a specific optical network unit is abnormal if the caught upstream optical signal or optical energy of the specific optical network unit is abnormal.

10. The system of claim 9, wherein the upstream optical signal or optical energy is determined to be normal or not according to a normal intensity range respectively set for each of the plurality of optical network units.

11. An optical fiber link monitoring apparatus for passive optical network, the apparatus being applied to an optical network configuration comprising an optical line terminal, an optical splitter, a plurality of optical network units (ONUs) connecting thereamong through optical fiber links, the plurality of optical network units being grouped into a plurality of groups such that each of the plurality of groups comprises a portion of the plurality of optical network units, the optical fiber link monitoring apparatus comprising:
an optical energy fetch element, configured to fetch upstream optical energy transmitted from the plurality of groups; and
a detecting/analyzing module, configured to detect intensity of the upstream optical energy and determine status of the optical fiber links among the optical line terminal, the optical splitter and the plurality of groups according to the intensity of the upstream optical energy.

12. The apparatus of claim 11, wherein the detecting/analyzing module comprises:
an optical power converting unit, configured to detect the intensity of the upstream optical energy; and
a central processing unit, configured to analyze the intensity of the upstream optical energy,
wherein if none of the upstream optical energy of a specific group of the plurality of groups is normal, then a specific optical fiber link between the specific group and the optical splitter is determined to be abnormal.

13. The apparatus of claim 12, wherein the optical power converting unit comprises a photo diode.

14. The apparatus of claim 11, wherein the optical energy fetch element comprises an optical splitter.

15. The apparatus of claim 14, wherein the optical energy fetch element further comprises an optical filter.
